(19) United States
(12) Patent Application Publication
(10) Pub. No.: US 2009/0230235 A1
(43) Pub. Date: Sep. 17, 2009

(54) Tambourine helicopter

(76) Inventor: Norbert Edward McNulty, Virginia Beach, VA (US)

Correspondence Address: NORBERT McNULTY, APT 104, 5516 CARROLANNE TERRACE, VA BCH, VA, 23462, US

(21) Appl. No.: 12/075,574

(22) Filed: Mar. 11, 2008

(51) Int. Cl. B64C 27/08; B64C 27/20; B64D 27/00; B64C 1/20

(52) U.S. Cl. 244/17.23; 244/55; 244/118.1; 244/117 R

(57) ABSTRACT

Disclosed is a profile of an end view of a base portion Vertical Take Off And Landing Craft, (VTLC) rotor-blade comprising a widened structure from leading to trailing edges. The profile further comprises straight level planes of air foil that provide the options of transforming the leading edge to the trailing edge. The rotor wing system is housed and duplicated in the craft set within said two wells which are circumnavigated by a corridor from front to aft of the craft. Two rear exits are reinforced by the connection of a triangular structure forming a tail which also affords a comprehensive view of the complete air craft perimeter from the viewpoint of a central top compartment.

### BACKGROUND OF THE INVENTION

Since the first helicopters, the problem of vibrations in forward movement have incurred a lift factor in the difference of the speed of the forward moving rotor blade combined with the forward speed of the craft adding to the lift on one side of the of the rotor's turret hub. The action is related to the difference of the lift between the rotor spinning in the reverse direction of the craft's forward movement, and the rotor spinning in the forward direction of the craft's forward movement. The blade moving on the back peddle direction incurs less overall forward (flight speed) therefore less lift is received from it than from the opposing rotor blade on the opposite side of the turret. The forward moving rotor presents proportionately a small fraction of the instantaneous differences in the rotor load change however, vibration problems from the opposing sides of the rotor turret add to metal stress. Because this condition even minutely exist, metal stress is a commonplace result of vibration. Tile invention disclosed herein addresses change in the rotor speed and the rotor shape in relation to the lift factor as a result of the inventions application to reduce vibration. Recently manufacturers of helicopters have begun to address the problem of convolutions in the rotors of their aircraft. Due to hundreds of vector changes in the pitch of their rotors (one per revolution) in relation to the back peddle of the rotors in relation to the forward and backward movement of opposing rotors, manufacturers must also regard the gyroscopic effect of vector changes in their rotors and how to assess and contain the resulting vibrations knowing the dynamics of the gyroscope do not change. The invention addresses the problem by eliminating the vector pitch change that occurs in each revolution in some existing aircraft.

Conventional rotors turn in the orbit of the circular path of the rotor blade. However when not moving they do not extend horizontally from the turret in a 90% angle but in an arc in relation to their central connection point on the turret hub. The rotors extend outwardly and down before the conventional aircraft takes off. The extreme peripheral orbit of the rotors' tips rise up from a drooping arc as the rotors accelerate. As they increase speed, the same outer orbit of the rotors' tips rise above their point of connection to the rotor hub introducing another metal stress on the system. The disclosed invention addresses and eliminates a generally large percent of this problem also.

### SUMMARY OF THE INVENTION

The invention is a profile of a rotor wing synergistically surrounded by encasements and shrouds that eliminates the drooping arc condition of conventional rotors before they accelerate.

The disclosed invention herein described has basically a profile of a wing rotor that incorporates the principle of a sharp edged, wedged, winged instrument cutting through the air in contradistinction to a blunt edged winged instrument of nearly the same proportions likewise not cutting but plowing through the oncoming airflow. The difference between the two functions of each is that the gradual parting of the oncoming air by the invention is that it displaces the identical size cavity of air in the atmosphere that a similar sized conventional wing does but the invention then instantaneously aborts the air displacement on its top airfoil surface by means of an abruptly encountered, airfoil chasm creating a cavity in the top of the wing that must be tilled with air pressure. The airflow separated from the airfoil takes longer to fill the invention's profile cavity than a conventional wings airfoil that incorporates no cavity in said conventional use. Therefore the invention leaves a structurally made chasm that takes longer to fill than it would if it were a conventional airflow surface with no chasm to fill. This concept is disclosed as applying it to a recreational craft and a commercial craft both of which utilize outer encasements to lock their rotor-wings into arcs that resemble and approach the underside arc of a parachute which enables the invention to incorporate the lift factor of a parachute in addition to the lift speed picked up by the chasm by the rotation of the rotor-wings profiles that utilize the constructed vacuum chasm in the structure of the wing.

### A DESCRIPTION OF DRAWINGS

FIG. 1 is a 15% side view of the recreational invention.

FIG. 2 Shows the end view profile of the rotor-wing.

FIG. 3 Shows the end view of the invention, prior art and their pressure point relation to the air flow over it.

FIG. 4 Shows the end view of prior art.

FIG. 5 shows the frame work of the rotor encasement harness of the rotor-wing turret system.

FIG. 6 The variable pitch apparatus base portion pulley support harness.

FIG. 7 Shows end view of rotor-wing profile and vector loop pulleys.

FIG. 8 Shows a 15% side view of the path of the turret pulley rope and some member portions of the system.

FIG. 9. Shows a side view member portion of the prime moving, weight lifting apparatus.

FIG. 10 Shows a ¾ view of the weight lifting apparatus.

FIG. 11 Shows side view of the prime mover pulley, racer, chair and chain.

FIG. 12 Shows the cog beads of the turret pulley rope.

FIG. 13 Shows the lower axle pulleys of the pitch control rope and the vector changing sleeve.

FIG. 14 Shows the top view of the rotor-wing, applied as a wing to a conventional craft.

FIG. 15 Shows the side view of the sane application in FIG. 14.

FIG. 16 Shows the end view of the invention applied to a motorized fuselage within a rotor well shroud.

FIG. 17 Shows the three quarter view of the fuselage embodiment that encases the rotor-wings. The back well is empty. The forward well shows top set of counter rotating rotors.

FIG. 18 Shows a side view of the commercial fuselage housing of the invention.

FIG. 19 Shows the top view of the commercial embodiment of the invention showing a vehicular cargo concourse and viewing lines at 9a and 9b.

FIG. 20 Shows the side view of the commercial embodiment of the invention's ability to receive motor vehicles.

FIG. 21 Shows the side view of the commercial embodiment of the invention set low on wheels with cargo ramps.

FIG. 22 Shows the sectional view of FIG. 9a and air flow path.

FIG. 23 Shows the end view of the invention with metallic airfoil in transformed profile.

FIG. 24 Shows an end view of the inventions' base portion rotor-wing set for a neutral coasting function and the transformation path of the wings' profile.

FIG. 25 Shows the ¾ view of the rotor-wings' internal mechanisms.

FIG. 26 Shows a three quarter end view and ribs of the motor driven rotor-wing.

FIG. 27 Shows the level sectional 9-a profile end view of the turret and fuselage disclosed in

FIG. 28 Shows a section of the tilted encasements and rotor-wing system with turret and fuselage from FIG. 19.

FIG. 29. Shows a ¾ schematic view of the inner portion glide rails that functions as one of the two outer encasements.

FIG. 30 Shows a ¾ of inner and outer encasement view of magnetic glide rail.

FIG. 31 Shows a view of the outer portion glide rail on its racer with roller wheels shown in

FIG. 32 Shows a side view section of outer encasements and their lifting jacks.

FIG. 33 Shows a ¾ back view of the rotor wells of the fuselage embodiment of the invention.

### PREFERRED EMBODIMENTS

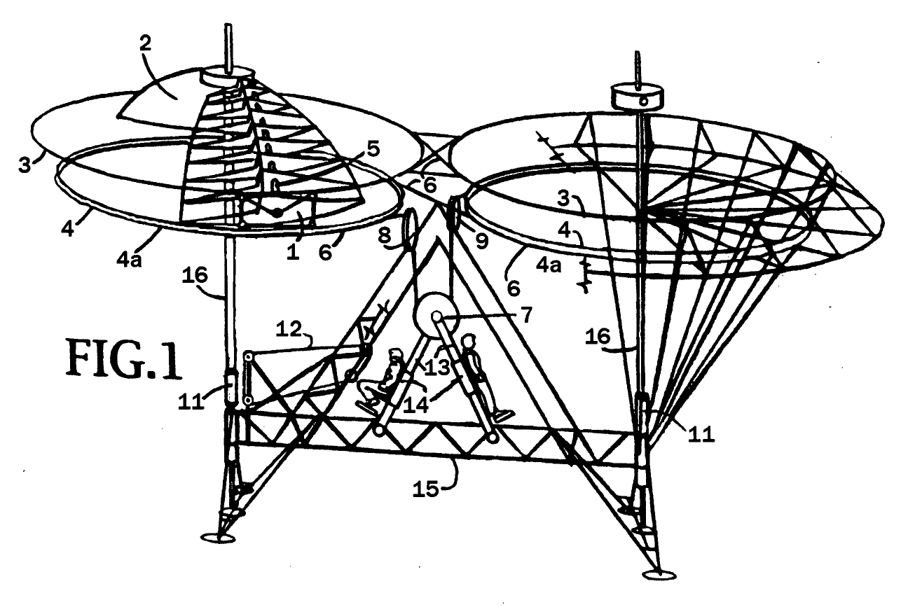

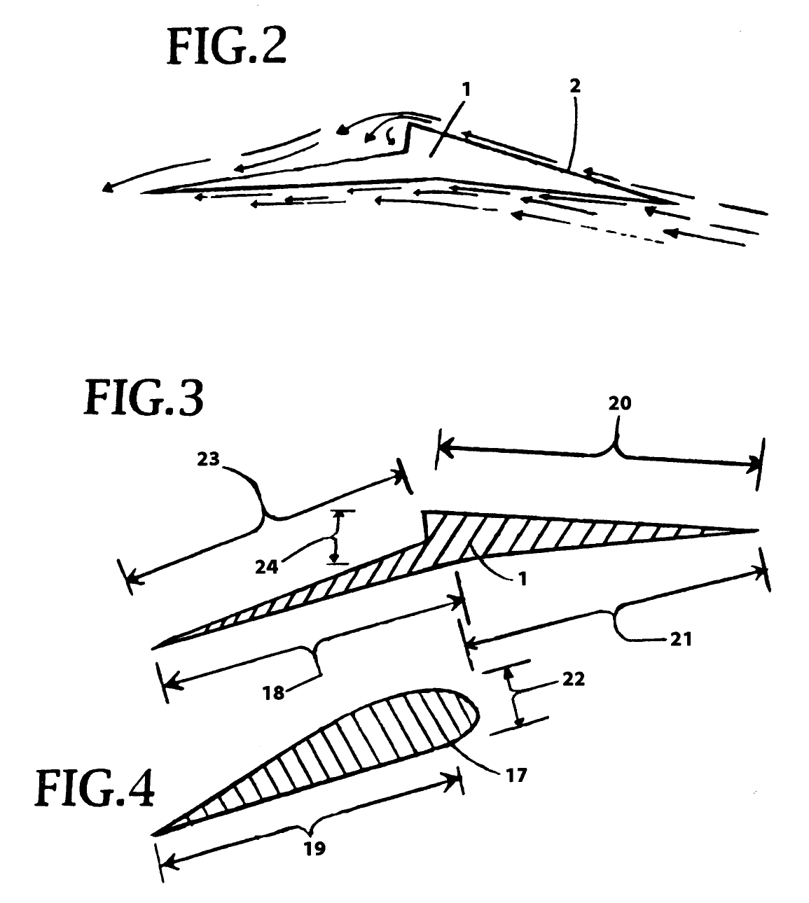

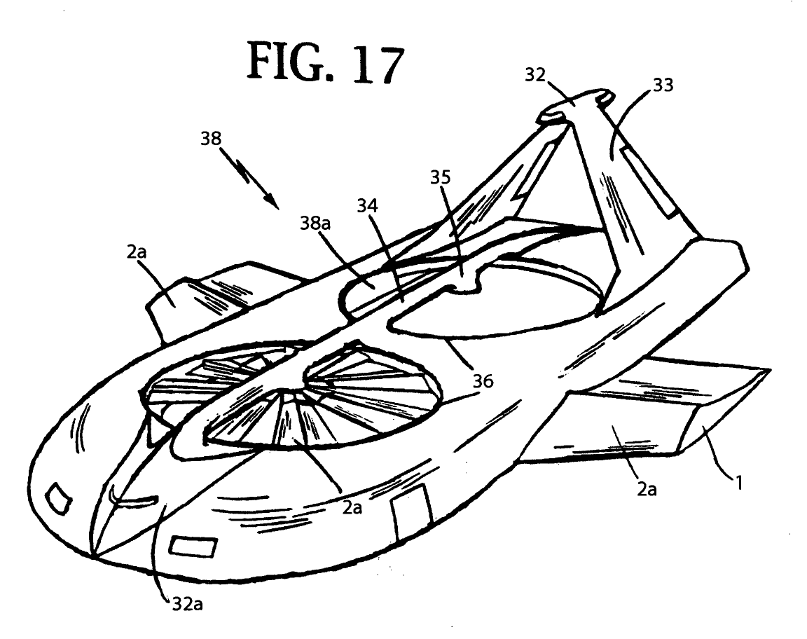

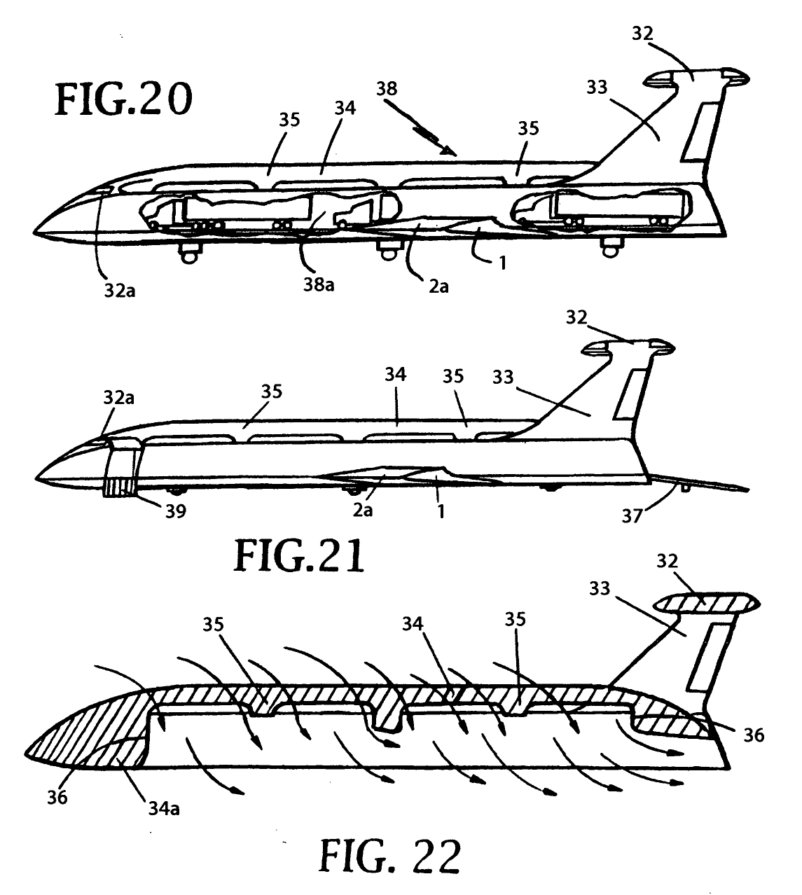

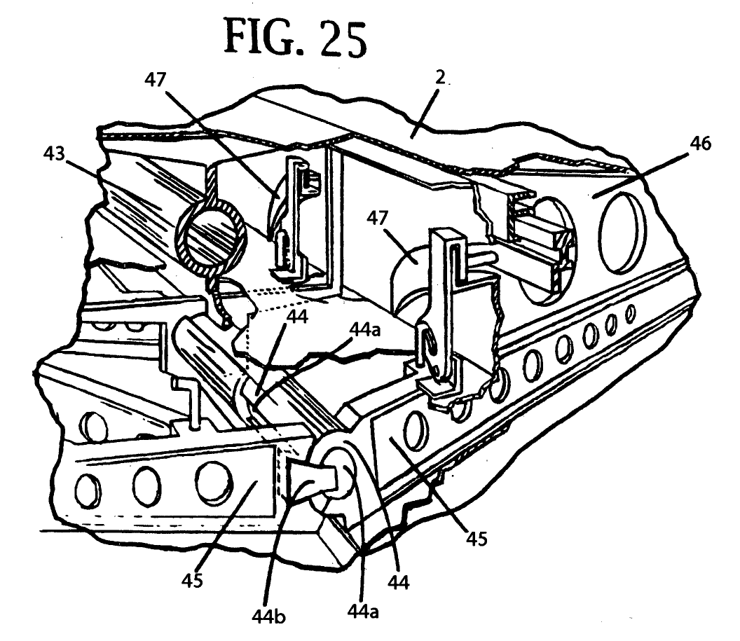

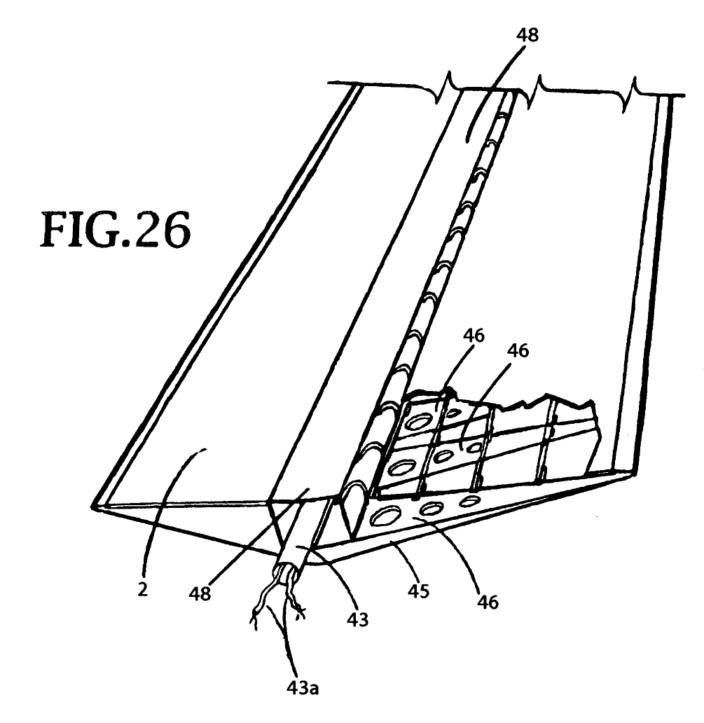

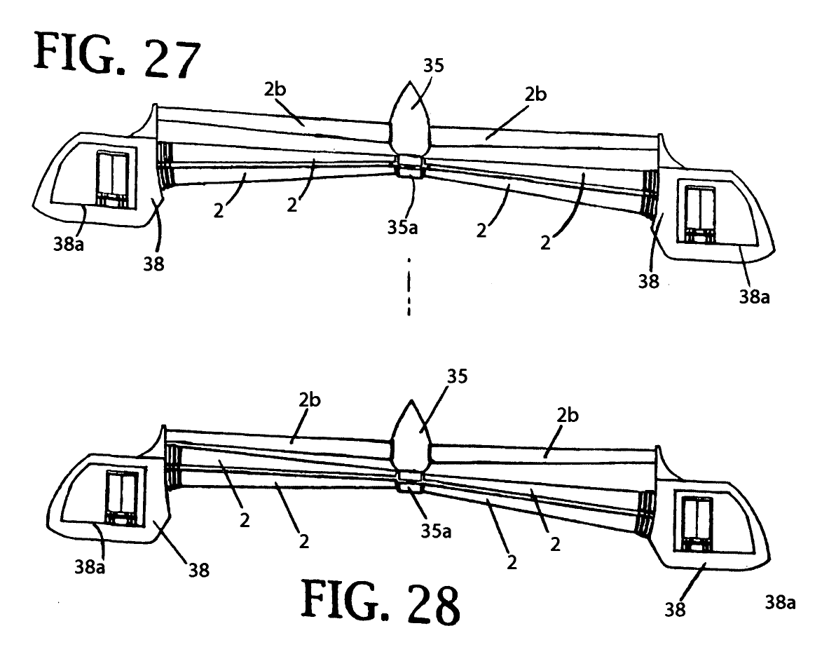

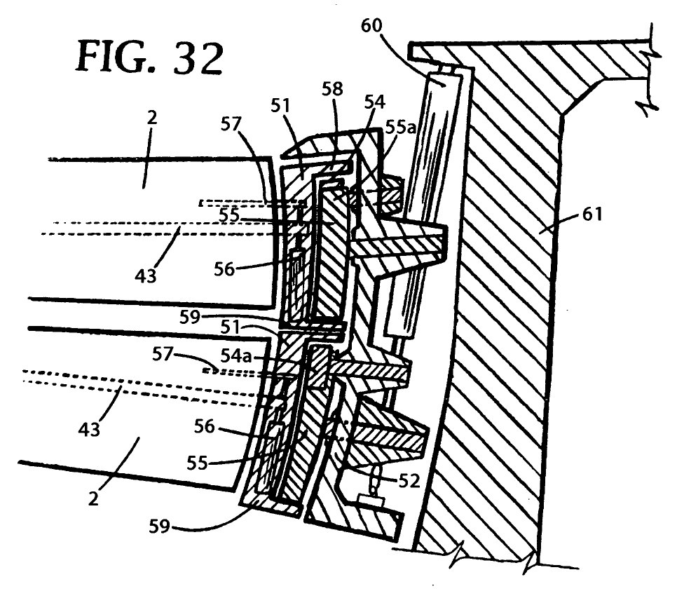

Disclosed is the profile of a helicopter, wing-rotor blade 1 synergistically applied to two helicopter fuselages, one recreational FIGS. 1. 15 and the other commercial FIGS. 16-21. 38. The commercial receives two rotor wells centrally located within said fuselage 38 that receive annularly in each well, two systems of rotors 2 and their outer FIGS. encasements, with two turrets 35 in each said well with vertical shafts 34 respectively. Means in more detailed disclosure the perimeter of each rotor blade station is formed by said rotor wells 36 that receive the base portion rotor wings FIG. 25, 2 herein called “wings”, “rotors”, “rotor-wings”, and “helicopter blades” which are shrouded concentrically by rings at their outer extremities FIGS. 32, 51, 51a, 56, and 56a which act as circular compartments or encasements that restrict the tips of the rotors FIG. 32 to stabilize an arc that approaches a Para dome configuration FIGS. 27 and 28 embodying said parachutes' lifting capability. The said base portion FIGS. 25 and 26 of the invention embodies two levels of counter rotating rotor wings FIGS. 27, 2 and FIGS. 28, 2a. Further disclosed is a said motorized aircraft having an inverted “V” formation 32 of a tail that supports a cockpit FIG. 32a angularly visible from every perimeter of the craft 38 and a forward cockpit 32a at the front end of a shaft 34 situated on top of the craft which functions as a bridge from the front to the back of said craft.

Further disclosed is a rotor-blade, wing profile 1 of a non-motorized vertical takeoff and landing aircraft FIG. 1 and a motorized vertical takeoff and landing aircraft FIGS., 16 and 16a through FIG. 21 that embody the base portion of both of the said crafts herein called rotor, rotor-wing, blade, and wing. The said non-motorized, recreational craft. FIG. 1. is a framework 15 supported by two sets of rotors 2 while it is in flight and by the said framework 15 when grounded. Its' base portion rotors 2 embody member portions of ribs 1 with silhouettes of the said rib profile 1 covered under a fabric 2 which is not shown on the for-ground wing of FIG. 1.) which profile is also used in the ribs 1 of the motorized helicopter FIGS. 16.-21 under metal foil 2a, as will be disclosed. The said rotor of FIG. 1. is moved by manpower on the recreational version of the craft and by a motorized prime mover on the commercial takeoff and landing craft (VTOL) 38.

Further disclosed is a man powered, recreational craft that has four rotor wings, FIGS. 1, 3, 2a. Two said wings in FIG. 1 are not shown for clarity. Each wing receives a centrally placed 5 tube through the thickest part of the middle of the ribs FIGS. 1, 3, 11, 2. In FIG. 1. the ribs are overlaid with said parachute cloth as an air foil. In FIGS. 1 and 2, the cloth is not shown on the rotor wing in the foreground of FIGS. 1 and 2 the ribs that form the profile of the surface pattern of the said rotor wing disclose an acute disruption of the path of the air flow stream FIGS. 3 and 24 that would normally follow parallel to the conventional foil of such a surface. Two sets of four wings each are received on the top of two sets of vertical axles 16 Said axils are embodied in the framework of the craft. The said rotor wings are attached to the said two sets of central axles 16 and extend radially outward from them where they are received peripherally by a base portion variable pitch apparatus FIGS. 1, 5, 6 and 7 which is mounted concentrically to said racers by member portion bearings 25 e, f, g, h, i, j on the inside of the craft's wing racers as shown in FIGS. 1, 5, 6 and 7. Said racers 3 and 4 are also concentrically mounted on the peripheral portion of the rotor-wing where they are also received by the framework 15 as the structure of the wing harness according to the structural art of the field. The said variable pitch apparatus 25 is a light metallic panel that receives four member part pulleys 25a, b, c, and d in each corner respectively.

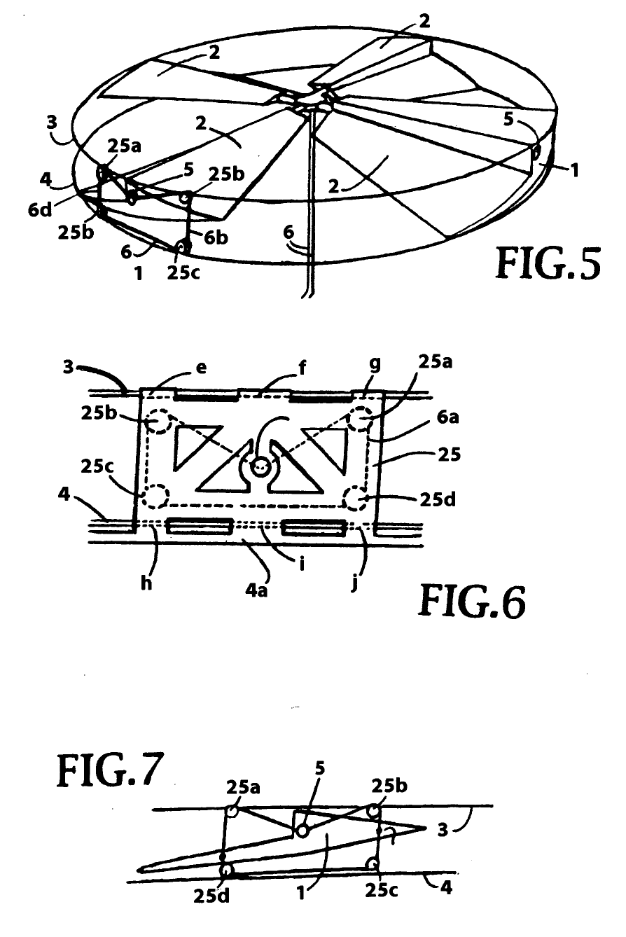

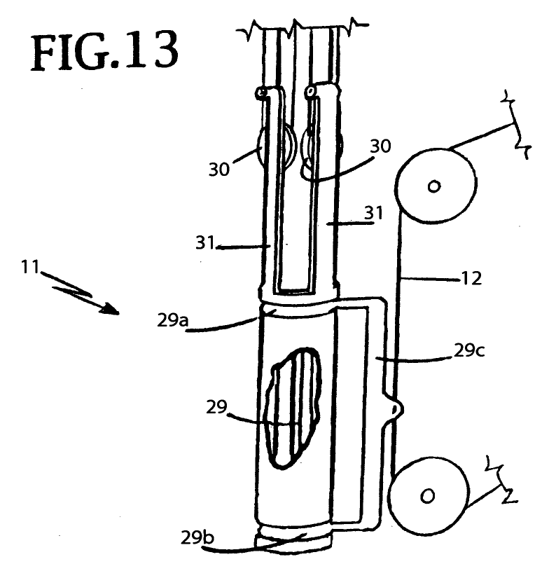

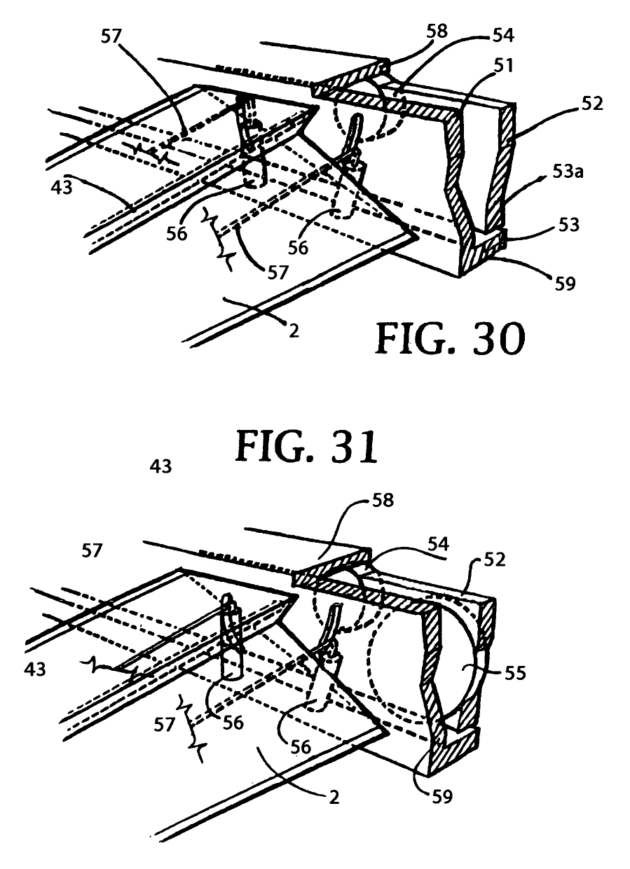

Further disclosed are the said racers which double as the harness FIGS. 5, 6 and 7. Racers are mounted to and received as member parts of the utility framework 15 In FIG. 1 structured and fastened according to the arena of the art. The said framework supports the rotor-wings when the craft is grounded and is supported by them in flight. Each rotor wing is stabilized by a centrally located spine tube FIGS. 1, and 5 which passes through the ribs of the wing and receives the pitch control lines 6a that pass through it. The lines run in a closed loop up the side of the axle from the lower control pulley 10 located near the bottom of the said axle 16. The said loop 6a continues up the axle to the top of it where it is directed into the wing's said tubular spine 5 which receives it inwardly and channels it from the hub to the outer variable pitch apparatus where its path extends outwardly beyond the spine 5 and around the said pitch apparatus FIG. 6 and the pulleys 25, a, b, c and d that receive the pitch loop rope 6a. It is received again by said spine tube 5 and channeled radially inward to the hub and back down the axle 16 to the lower pitch loop pulley 10 thus completing its loop. When the said loop passes around the variable pitch apparatus FIG. 6a. 25a, b, c, and d, it is fastened to the end rib of the wing by two fasteners FIG. 6. and FIGS. 7, 6k, and 1, one toward the leading edge and one toward the trailing edge of the profile of the wing extremity before and behind the outer extremity of the said tubular spine 5 so that when the said loop moves up or down the vector of the pitch of the rotor wing moves up or down. At the other end of the wing's pitch loop system the lower axle pulley FIGS. 13, 30, is mounted on the said axle sequentially spaced in tandem with three others to receive four rotor wing loops 12 three (not shown) and located near the axle bottom 16 of each axle. A set of four lower pulleys 30, along with the pitch loops 6a turn with the axle. The said loop 6a received by the pulley system is turned manually by a second closed loop 12 under the control of the pilot. To avoid twisting the vector control loop 6a around the axle. Each loop is connected to a splined sleeve FIGS. 13. 11 that does not rotate as the axle spins. The said axle 16 receives the said sleeve 11 which receives a bore (not shown) with splines 11a that are received by grooves in said axle. The said sleeve 11 spins with the axle and embodies two flanges shown in FIGS. 1 and 13, on each of the two axles on the said invention (one is not shown). Each receives two washers 29a, and 29b, that are mounted annularly around the top and bottom of the sleeve. Each said washer spins freely around the said sleeve. Each is joined together by a handle 29c that connects with the pilot's loop 12 which moves the sleeve up and down by the handle 29c. Four spikes 29d extend upwardly from the pitch loops' sleeve 11. They are attached to the pitch loop 6a means the pilot can move the sleeve, 11 the spikes 29d, the pitch loop 6a itself and the vector of the rotor wing 2 up or down by pulling a hand lever loop 12 which is received by and attached to the said sleeve 11 of the pitch loop 6a and framework as shown in FIG. 1. When either pilot pulls on their said hand lever loop 12 the said variable pitch apparatus loop 6a changes the angle of attack of the said rotor-wings.

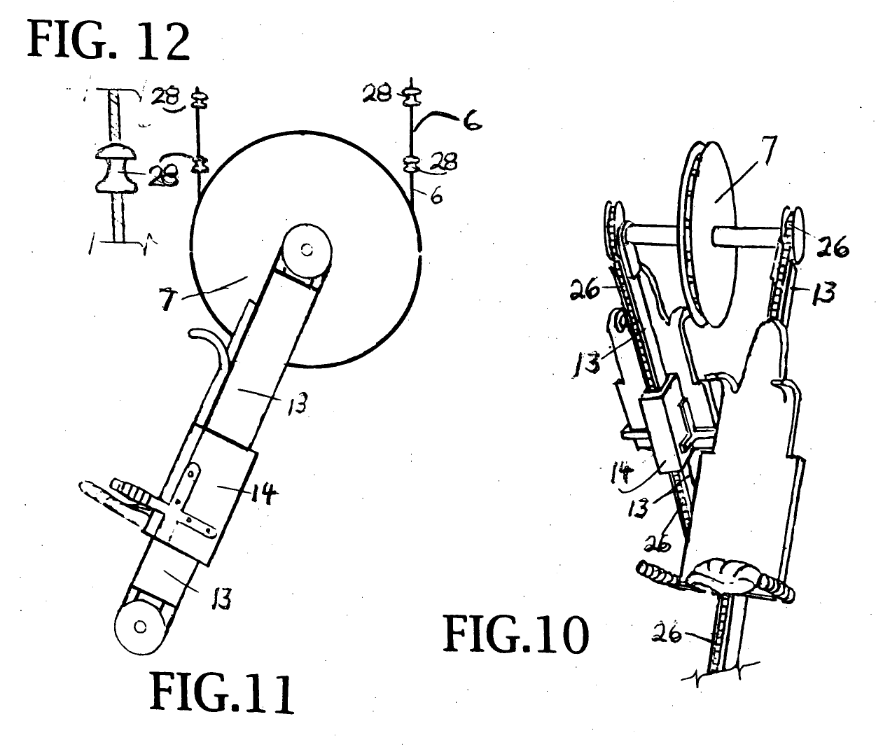

The body harness prime moving mechanism means only power source, FIGS. 9; 10, 11, and 12 receive a turret loop rope 6 in FIG. 1, which tows the rotor-wings 2 orbitally and is the extension medium of the kinetic energy of the prime mover pilot FIG. 9, who sits on a lift chair FIG. 10. which is embodied in the member portions of the chain 26, the racer 13, and said gliding, ratchet box 14. The initial force for flight is applied to the rotor wings 2 by the said rotor-wing loop rope 6 which is received by the first pulley 7 in the prime moving system located directly above the heads of the prime moving energy source,—the pilots—and turned by the physical lifting of both pilots on the base portion ratchet chain box 14, the racer 13, and chain 26 which are embodied on the backs of their chairs. The said rotor-wing loop rope 6 is incremented to match the receptacle cavity notches 27 in all of the rotor wing pulleys starting with the prime moving pulley 7 of the system followed by two distributor pulleys 8 and 9, directly above them to the tubular rotor-wing pulleys 4 that are concentrically received by their racers 4a and 3 which are mounted to said racers by conventional bearings FIGS. 6. e, f, g, h, l, and j. The four variable pitch apparatuses 25 of each rotor-wing assembly are member parts of the said rotor-wing pulleys 25 a, b, c, and d, and rotate with them. The racers 3 and 4a encase the said rotor wing pulleys and structurally form a harness for them to the framework 15. The two rotor wing assemblies turn at the same speed by the same exerted energy. Means no matter which pilot is pulling harder, both sets of rotor-wings 2 turn the same number of revolutions per minute. The said rotor-wing loop rope 6 spins both rotor-wing pulleys 4a simultaneously with their member parts, the variable pitch apparatuses (vector apparatuses) 25 which in turn rotate the rotor-wing assemblies 2. By pulling the vector loop 12 and thereby changing the attitude pitch of the rotor wings 2, one pilot can raise or lower his end of the aircraft and incur directional flight. Means the change of pitch not the speed, on one set of rotor-wings 2 incurs increased or decreased lift independently from the other set and enables directional flight movement and therefore the activation of the tail fin 12a. The pilot, as the prime moving source can take a rest from applying power by changing the vector of the pitch apparatus 25. It may be changed to a downward, descending angle of attack and the said rotor-wings 2 will spin by themselves in a downward flight path and glide the craft to a landing with no prime moving power expended.

The said framework apparatus receives said body harness FIG. 10 embodied as a member part of the structure that supports the man power of the said prime mover. When pilot is lifting or reclining, the body harness embodies a member portion gliding box 14 that receives four conventional ratchets that allow the pilot to lift and rest using his own weight to ride down to the lift level 14a. Means when at rest his own weight is simultaneously applied to tile prime moving force utilized to turn the rotors.

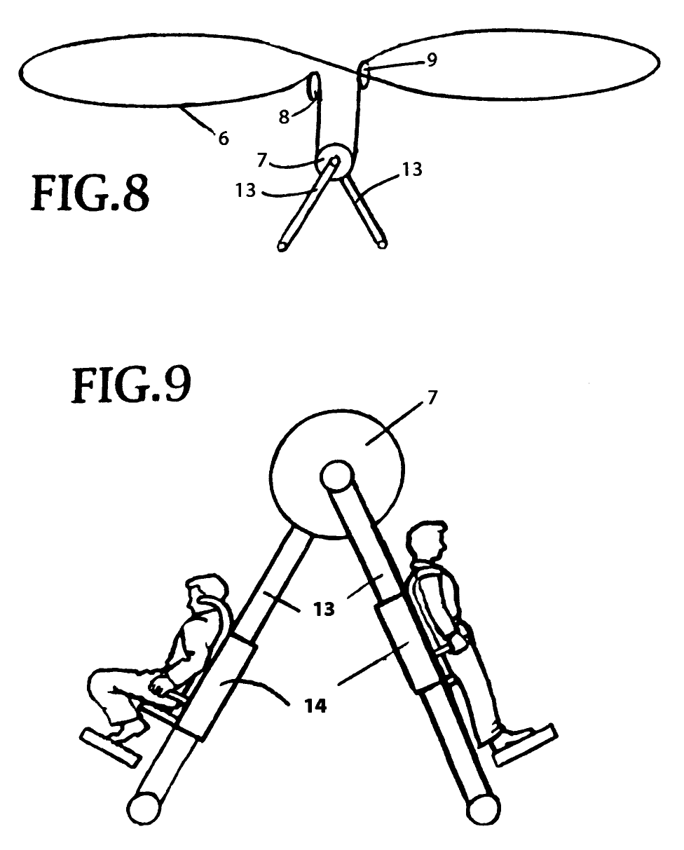

The body harness mechanism FIG. 10 and the pitch apparatus 25 receive between them said rotor-wing loop rope FIG. 8 which tows the wings orbitally and is the extension medium of the kinetic energy of the prime mover pilot FIG. 9 who sits on the said lift chair FIG. 10. The said turret loop rope receives double disked dumbbell shaped beads 28 sequentially embedded in the tow rope equidistant from each other 28, which are received in the said notches 27 of all the pulley portions in functional contact for turning the said pulleys and the rotor-wings 2.

Further disclosed is the invention's rotor-wing profile FIGS. 1, 2, and 3. The said helicopter blade invention is presented in the profile FIG. 3 showing the middle of its width 22a to be the thickest part of the device's structure which further discloses the surface of the top foil of the leading edge to begin at the most forward point 20, 21 of the apparatus at a common tangent with the foil surface of the bottom leading edge 21. The top said surface 20, in relation to forward flight, extends from the front to back middle width of the top of the rotor wing in an upward slant. The bottom toil extends from the leading edge all the way to the back edge of the profile 1 at a downward angle to the end of the bottom width of the wing. At mid wing the top foil drops vertically and acutely downward toward the bottom foil in an irregular direction related to the air stream flow that the toil would normally be structured to parallel 2. At mid wing the vertical drop creates the condition for an instantaneous and immediate physical low pressure cavity disposing the oncoming air flow to a more acute and complete vacuum than would be formed if the air foil continued to the back of the trailing edge as in a conventional and symmetrical curve FIG. 4. In the directional course the said air stream follows in its path from the leading edge toward the top of the middle of the wing, the speed of the air flow passing over the aircraft and the depth of the middle cavity become the predominant factors in determining the strength of the vacuum above both old and new profiles 1 and 17. In the disclosed invention profile 1 the said top surface of the trailing airfoil 25 has been lowered proportionately against the top of the bottom surface 19 as it is also disclosed in the motorized versions profile FIG. 22. The said airflow which passes over the middle half of the trailing edge of the rotor is then separated further and longer from the top surface of the trailing edge of the invention compared to the profile presented in FIG. 4. The area of air pressure lift on the bottom foil of both wings FIGS. 3, 4 receive an identical contact from the air stream passing under them. On the disclosed invention profile 1 the airflow over the top foil of the area of the sections addressed 18, 19, 21, in FIG. 3, does not come into consistent or equal contact to the top foil of the same area of the bottom conventional profile addressed 19 in FIG. 4. Means exhibiting less airflow contact with the said top air foil 25 generates less pressure on the top foil 25, means more pressure on the identical area of the bottom foil, 18, 19 means more vacuum on the said opposing top area surface, means more lift to the addressed section 23 of the invention.

The forward leading edge of the said inventions' profile 20 is dissected into equal air displacement surfaces in relation to a center line 22b of FIG. 3. The profile of the prior art FIG. 4 represents essentially the same thickness of an example wing as the said invention so concluding that a comparison is simply stating the same volume of air is parted 22a, 22b, by the leading edges of both said profiles. In the said profile of FIG. 3 the leading edge 20, 21, is shown to indicate lift is not the purpose of the said leading edge in the disclosed attitude of the rotor wing invention 1. The said leading edge profile 1 shows its purpose intended is to simply part the oncoming airflow with a minimum abutment resistance on both the said recreational and said motorized 22, 23, embodiments. Means the disclosed function of the leading edge of said invention 1 is to pass the complete rotor wing through the air with less prime moving force of energy expended than the obtuse 22b leading edge of the said commercial profile.

Adhering to all guidelines of measuring all proficiency of all wings and rotors, examined in the same attitude of pitch, all forward lift appropriated by section 18 and 19 is measured in foot pounds of pressure related to the horsepower and consequential air speed used in propelling both profiles FIG. 3 and FIG. 4 against the wind.

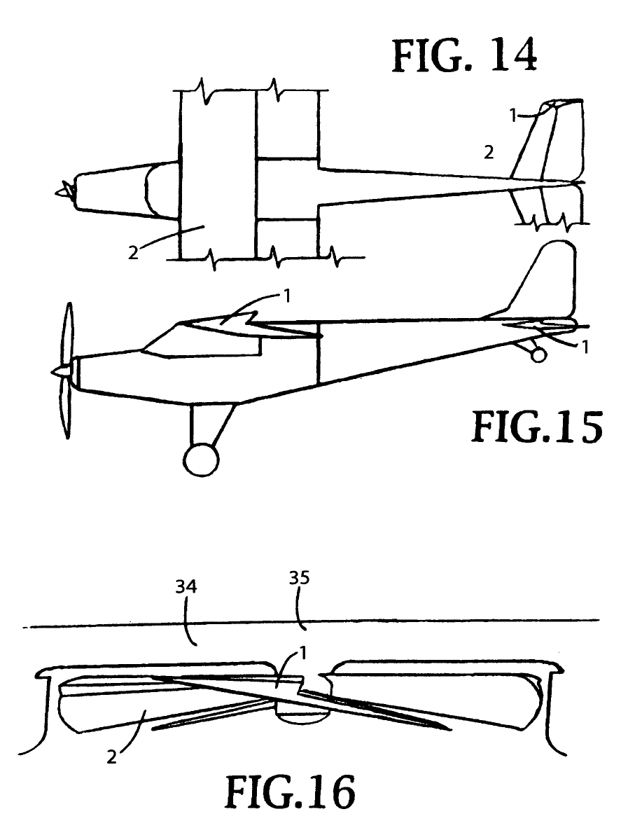

The rotor wing apparatus may be functionally added to a conventional air craft as a conventional wing as in FIGS. 14, 15 and as a rotor without peripheral encasements FIG. 15. Further disclosed is a motorized vertical takeoff and landing craft FIGS. 8 and 9 consisting of a base member part that embodies essentially the same profile 1 of the said recreational rotor wing. The said “rotor wing” 1 is moved by manpower on the recreational version FIG. 1 of the craft and by motorized power on the commercial vertical takeoff and landing craft (VTOL) herein called helicopter FIGS. 16 and 16a.

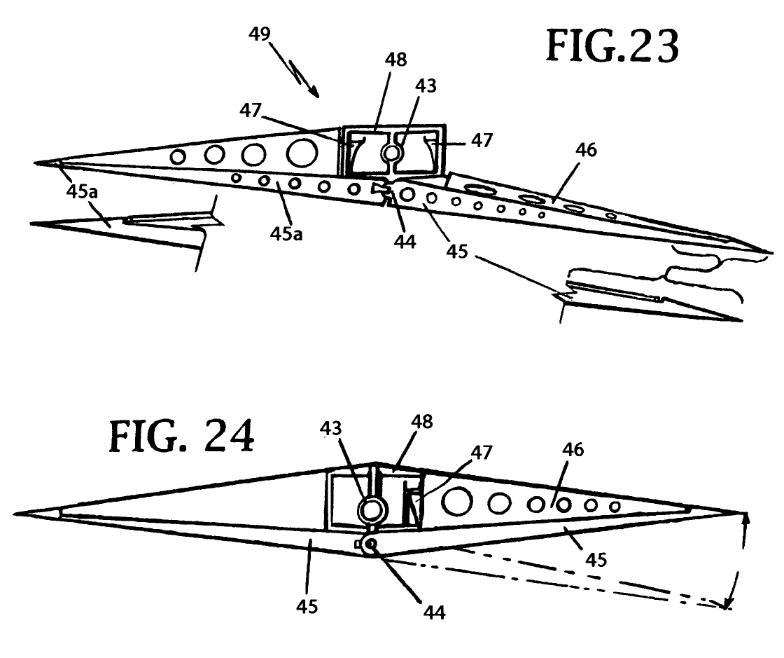

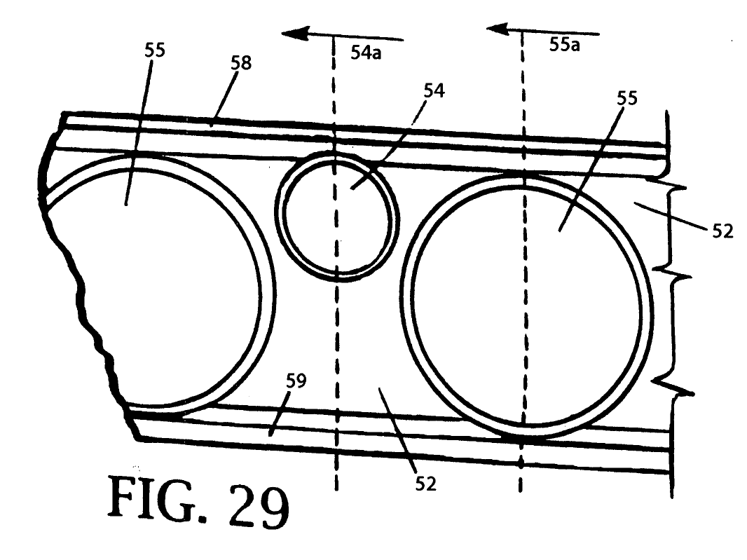

Further disclosed is a commercial helicopter with a split fuselage and an inverted “V” shaped tail fin projecting out of the top, back portion. Said fuselage encases two centrally embodied circular sets of rotor wing wells that embody two sets of counter rotating rotors within each set of wells. Each of the said wing-rotors embodies two metal tube shaped spines located one above the other 43, 44 shown in FIG. 32, and FIG. 29, that pass through the middle of each rotor wing FIG. 25. The spines are both housed in a metal rectangular channel 48 FIG. 22, and FIG. 23, that extends within the said wings' metal airfoil from the turret hub FIGS. 27, 35a radiating outward to the first of two encasements FIG. 30, 51, 52 The said first encasement is received annularly by and enshrouded by the second encasement 52 which is received by and enshrouded annularly by the fuselage wall FIG. 32, 61. All three said member parts 48, 43, 44 extend to the outer perimeter of the rotor-Wing FIG. 25, 48 except the central spine 43 that extends beyond the wings' outer extremity and into the first of the two said circular rotor encasements 51 shown in FIG. 32.

The said tubular top spine 43 receives through it the wiring for the pitch control screw jacks 56 shown in FIGS. 29, 30, and 32. The lower tubular spine consists of two member portions of an axle system shown in FIGS. 22, 23, 24, and 26, that supports the wings' trailing and leading edged ribs 45, 46. The outer member of the axle 44 receives a bore through which passes the second member part axle 44a. The said axles both receive strip cuts 44c, 44d for the full length of the parts that are coordinated to receive connector keys through them for the full length of said axles. The inner axle's extrusion is a channel cut the length of the tube. The outer axle's cut is an extruded splice cut completely through the wall of the said axle 44 continuing the length of it. A keystone shaped connector 44b joins inner axle 44a to its ribs 45. for the securing of one half of the rotor-wings' base portion ribs 45. Said ribs are sequentially spaced on the outer base member from the hub radially outward to its termination point toward the first peripheral encasement. FIGS. 29, 30, 32.

The outer base portion of the axle system receives the said extruded splice on tile opposite side of its' base potion ribs. The said splice receives the key stone shaped connectors 44b that secure one set of member portion ribs 45. The said outer axle is tubular and receives the said solid rod 44a as the inner axle. The said rod is the axle that receives a corresponding groove 44c that receives the opposite end of the said connector key 44b to secure it's member part ribs 45 Both of the said bottom axles lift and lower the leading and trailing edge of the rotor wing 2 respectively by activated electric screw jacks 56. The electrical power of the said screw jacks is accessed by wiring delivered through the central said spine 43 The screw jacks 56 change the vector of the pitch of the rotor-wings. They are located in the first peripheral encasement 51, 51a shown in FIG. 32 in which they move the pitch of the wings up or down. The said wiring 43a actuates both jacks 56, 56a simultaneously in coordination with a series of six or more sets of jacks like them located in the outer end of all rotor-wings around the same said inner encasement means the leading edge of the rotor wings may be transformed into the trailing edge during flight as needed for mid flight coasting or a neutral airflow position. FIG. 24. The said transformation is activated by the series of said member part wing ribs 46 shown in FIG. 25, 46a. As either edge transforms from leading or trailing the rib structures fold on a series of sliding runners 46a (shown in FIG. 25) attached to the under side of the foil 2a.

The top edge of all the ribs, toward the mid wing is attached to the rectangular box 48 that encases the said spine. As the said base portion axle rib 45 and the grafted in member portion ribs 45a are lowered or raised by the said screw jacks 56 the said ribs 46, fold down or up to a flat or raised position by following the groove 47 up and toward the rectangular spine 48 or down and away from it thus coordinating the said ribs 46 folding movement with the movement of the base portion 45 and attached member portion ribs 45a.

Further disclosed is a vertical lift aircraft embodying rotors in a Para dome configuration FIG. 27, 2 annularly received located in the fore and aft rotor-wing 2 wells 36 of said fuselage described herein as helicopter, which embodies a cockpit attached to the top end of an inverted “V” shaped tail 33 with an internal width to allow exit and entrance to the said cockpit 32 from within the fuselage upward through the inside of the said tail 33 of the craft. Disclosed is a pilot compartment that is enjoined to the crafts' said inverted tail embodied at the top tangent of the two angularly upright base portions of the said tail 33. The cockpit 32 extends forward over the back rotor well 36a and backward over the cargo entrances 37 and 37a, means the perimeter of the entire outer profile of the craft may be visible from the combined forward and aft windshields of the said cockpit 32. Means the operator can visualize the complete perimeter of the craft means accidental maneuvering conditions are minimized. Visibility is enabled the embodiment of aerodynamically placed windshields in the for and aft of said cockpit 32. An aerodynamically formed horizontal shaft 34 passes centrally over the entire length of the craft from front to back. It embodies member parts including a front cockpit 32a, two turrets 35a and 35 incorporating four drive shafts not shown. The engines are housed off the middle of the craft towards the sides 40. The said shaft 34 assumes an elevated position when passing over the turret wells 36 and 36a. It assumes a structural path parallel to the aerodynamic flow of the top foil of the craft and blends into it as it terminates at the back. Four optional stabilizing wings 2b shown in FIG. 27 which dissect the shaft at the two turret housings 35, each passes laterally over the center of the rotor wells 2a and 2b. They connect laterally at tangents on the top outer edge of each said well 36 and at each side of each housing of each of the two said turret hub portions 35, 35a of the rotor system. FIGS. 27 and 28, 35, 35a, 2a, 2b, and FIG. 30, 51, 52, 60, 61. The said stabilizing wings swivel to rotate to an attitude of least wind resistance to accommodate the vertical and forward air flow of the craft FIGS. 16 through 21 on which it is optionally not shown. Means, if used at takeoff, the stabilizer changes from an upward attitude to a forward attitude to accommodate the difference of the air flow between the forward speed of said craft and the downward torodial airflow thrust through the said rotors. FIG. 27, 2b. Said wing is not intended for direction flight or directional trimming.

Disclosed is a VTOL aircraft that embodies a split fuselage that annularly receives two identical turret systems 35, 35a. The said two identical turret systems in both rotor wells are herein described as one representing both. The rotor well receives centrally the base portion of two sets of counter rotating rotor wings 2 and 2a one above the other. They are received on their inner extremities by a member hub portion 35a. On their outer extremities by a member portion circular harness embodying two shrouds that are herein called inner and outer “encasements”, “shrouds” and “harnesses” 51, 52, that are mounted between the centrally located member portion turret hub 34, and the outer fuselage wall 36. Said hub portion is situated in the center of the said rotor well system 36. The said inner encasement portion FIG. 32; 51 of two peripheral encasements receives a tubular spine 43 that extends radially beyond the base portion rotor-wing 2 into said inner peripheral encasement 51. Means the rotor wings in each of the two levels of rotors in each well are harnesses that the rotor wings are locked into by the inner peripheral encasement that receives the central spine 43 that protrudes through and beyond the outer end of each wing FIG. 25 and FIG. 32. The said spine 43 is received by the first peripheral encasement by appropriate bearings that the wing swivels on in order to change pitch. The said two peripheral harnesses are each received in the circular well made up by the circular walls of the fuselage 36. The rotor wings FIGS. 25, 27, and 28, 2 move in opposite directions in the proximity of two orbital paths separated by a distance of less than half of their maximum pitch height FIGS. 27 and 28; 2, 2a. Means the rotors at their highest pitch do not close the gap between them in a collision path. Examining just one base portion rotor system representing both identical systems it is disclosed herein that embodied in it are two member portions of the system FIG. 32. 51, 51a and 52 which embody four gliding tracks 58,58a and 59, 59a that hold the counter rotating rotor wings at a consistent distance from each other's level of orbit to avoid collision. The single outer perimeter encasement FIG. 32. 52 embodies two principle member parts—the load bearing coasters 55, 55a along with the smaller landing and shut down coasters that the rotors 2 come to a rest and stop on and the load bearing encasement screw jack 60 that the major portion of the aircraft weight is distributed on. Two concentrically placed shrouds receive the upper and lower gliding rail member portions 58, 55. of the inner encasements 51, 51a rotate with the rotors which they stabilize in their attitude changes. The outer said rotor-wing encasement does not rotate but tilts on its own directional vector supporting the major portion of the weight of the aircrafts' load. It shrouds the inner shroud and receives a multiple number of said wheels 54, 5a as member portions which support the inner most encasements' glide rails (herein also called racers) 58, 59, 59a. The said outer encasement ring (the second ring from the central hub) 52 is concentrically located on the outer most perimeter of the inner encasement. 51, 51a at sufficient distance from the fuselage wall 61 to allow it to oscillate by tilting up or down from any point on the said wall 61 in direct reference to the movement of the said screw jacks 60 that are connected to the fuselage wall and to the lower part of the outer encasement portion 52 means it moves up or down and maintains direct reference to the attitude or tilt of said rotors and turret, hub and drive shafts, means the craft will directionally move in relation to the tilt of the second encasement 52 on any angle within its 360 degree option. Means the craft's direction movement is subject to directly reflect the pitch vector of the movement of the said outer, rotor, wing shroud 52 without a counter rotation propeller, means in a synchronized action, the jacks 60 tilt the complete harness of both linked shrouds along with said linked rotors and turret mechanisms in each of the two upper and lower sets of rotors of the rotor wells 36, 36a. Means the prime mover of the rotors are not tilted in directional attitudes from the turrets of the helicopter through the centrally located hub 35a but from their outer edge encasement 52 and consequently control the course of the aircraft's direction, eliminating the necessity of anti-rotational devices such as anti-rotational vertical propeller or louvers to direct the aircraft and from the extra drag that accompanies said louvers. Means during flight they furthermore eliminate conventional drag of said louvers on the Torodial air flow through the wells 36, 36a. The lower, second set of said rotors 2a move in independent, counter rotation from the top set 2 in each said rotor well system. Means that in themselves, they stabilize the fuselage from counter rotating. Means stabilization capacity is compounded by two sets of said rotor wells 36, 36a.

The drive shafts are received by the bridge 34 and linked to the prime mover in the center of the craft by the art of the arena.

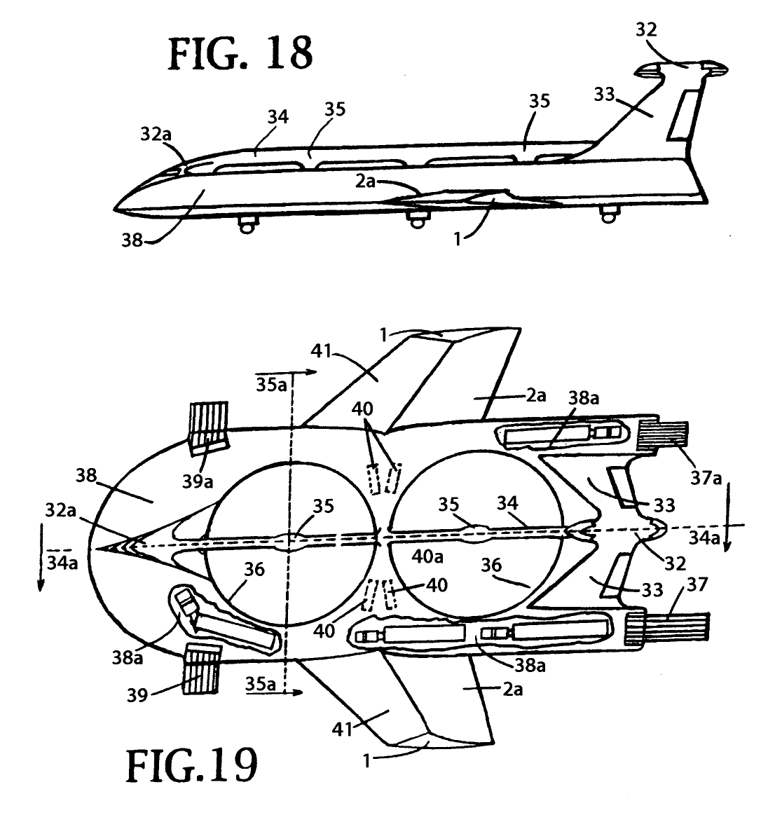

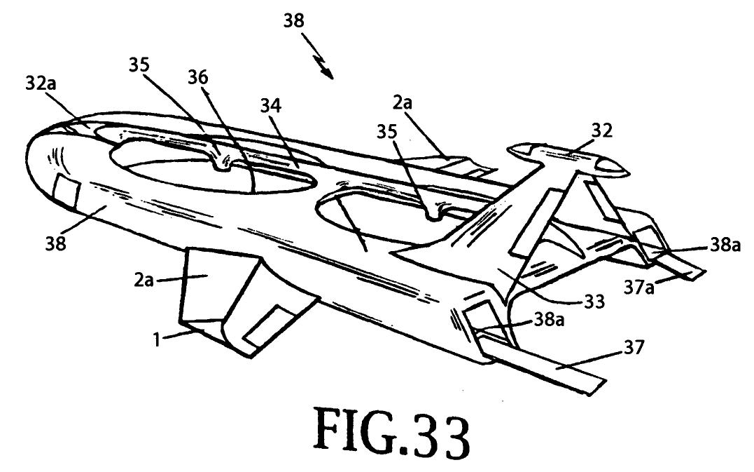

Further disclosed is a vertical lift aircraft FIGS. 33 and 16 through 21 in which the fuselage embodies a cargo hull that extends from two back right and left twin entrances 37, 37a to the front of the craft in two adjoining causeways 38a, 38b that lead to a semicircular concourse around the front of the craft from either side to the other. The moving traffic may exit one of the two front exits 39,39a or continue moving around the said causeway through the front of the fuselages to the back again and exit through the opposite twin exit from the one entered. Furthermore disclosed are four sets of cargo doors 37, 37a, 39, 39a that constitute four entrances and exits adjoining said causeways 38, 38a in FIG. 18 which receive immobile cargo and moving traffic which may enter and exit the craft four different ways without reversing vehicular direction FIG. 18. Two ramps at the back 37, 37a in FIG. 33 may extend horizontally and angularly in complete, comprehensive view of the back cockpit 32 and thereby be extended 37 to create emergency accessibility to otherwise inaccessible high rise structures and thereby create boarding and loading activity as an emergency aircraft.

I claim:

1. An end view profile of the base portion of an aircraft wing embodying a structured chasm on its top foil that introduces a sudden and more complete vacuum cavity to the art of aeronautical lift and a sharp wedge like leading edge that introduces the invention to the air flow it passes through without a blunt abutment but conventionally a less wind resistant leading edge.

2. A manually driven rotor-wing system installed in two rotor wells in a recreational frame work having two structured peripheral encasements embodied in the structures to house them as two helicopter (Vertical Take Off and Landing ) craft turrets with rotor wings in tandem with each duplicate.

3. A manually driven rotor-wing described in claim one mounted in two encasements which are part of the structural framework embodying a weight lifting apparatus as prime mover in contradistinction to a peddle device.

4. A wing-rotor as in claim 1 mounted a commercial motorized fuselage in encasements on its outer perimeter and on a central hub within the fuselage of a VLTO craft.

5. A wing that directionally moves the motorized craft by hydraulically tilting the pitch and attitude of the rotors by hydraulic lifts on the outer perimeters of said encasements. Means the encasements are the source of the directional movement of the craft in place of the angular pitch change of the rotor wings.

6. A base portion rotor-wing system that embodies outer encasements that glide on secondary outer encasements on racers comprising wheels or magnetic cushion with the prime mover as the turret.

7. A base portion rotor-wing that is housed by outer encasement that magnetically lift and drive the rotor wing system independently from the turret or simultaneously with it.

8. A rotor-wing that may be stopped in mid flight and actuate the transformation of its leading edge to a trailing edge for coasting of the craft by reason of an optional added power source.

9. A wing having a fuselage that enshrouds it on its outer peripheral tips and peripherally bears the distribution of weight with the central turret to eliminate a factor of metal stress.

10. A wing rotor system set in two levels that counter rotate in two separate rotor wells in one Vertical Take Off and Landing craft that do not bend upward during acceleration of the turret.

11. A wing-rotor system synergistically housed and utilized by a fuselage that embodies two rotor wing wells centrally located in the fuselage with a causeway leading around them from back to front forming a cargo corridor though which moving vehicles may enter and exit without reversing direction.

12. A base portion fuselage that embodies an aft inverted “V” formed tail having a cockpit on top structurally giving the operators visibility over 360 degrees of the lower perimeter of the craft and a shaft running the top full length of the craft with a second cock pit in front.

13. A VTOL rotor-winged system that can change the attitude of each of its rotor-wings to a downward pitch means to accommodate a dead stick landing in the event of a release of power.

14. A base portion rotor-wing that Automatically reverses its direction and acts as a glider to diminish the rate of descent or accommodate a cruse in relation to any secondary and faster prime moving power that may be installed for forward progress.

15. Furthermore disclosed are four sets of cargo doors that constitute four entrances and exits adjoining said causeways which receive immobile cargo and moving traffic which may enter and exit the craft four different ways without reversing vehicular direction.
